(19) United States
(12) Patent Application Publication
(10) Pub. No.: US 2022/0188612 A1
(43) Pub. Date: Jun. 16, 2022

(54) NPU DEVICE PERFORMING CONVOLUTION OPERATION BASED ON THE NUMBER OF CHANNELS AND OPERATING METHOD THEREOF

(71) Applicant: SAMSUNG ELECTRONICS CO., LTD., Suwon-si (KR)

(72) Inventors: Junseok PARK, Hwaseong-si (KR); Suknam Kwon, Seongnam-si (KR); Changsoo Park, Hwaseong-si (KR)

(73) Assignee: SAMSUNG ELECTRONICS CO., LTD., Suwon-si (KR)

(21) Appl. No.: 17/496,037

(22) Filed: Oct. 7, 2021

(30) Foreign Application Priority Data
Dec. 14, 2020 (KR) 10-2020-0174731

(51) Int. Cl. G06N 3/063

(52) U.S. Cl. CPC G06N 3/063

(57) ABSTRACT

A method of generating an output feature map based on an input feature map, the method including: generating an input feature map vector for a plurality of input feature map blocks when the number of channels of the input feature map is less than a certain number of reference channels; performing a convolution operation on the input feature map based on a target weight map and an additional weight map that has a weight identical to that of the target weight map, when the target weight map numbers less than a reference number; and generating an output feature map based on the performed convolution operation.

### CROSS-REFERENCE TO RELATED APPLICATION

This application is based on and claims priority under 35 U. S. C. § 119 to Korean Patent Application No. 10-2020-0174731, filed on Dec. 14, 2020, in the Korean Intellectual Property Office, the disclosure of which is incorporated by reference herein in its entirety.

### BACKGROUND

### 1. Technical Field

The disclosure relates to a Neural Processing Unit (NPU) device and an operating method thereof, and more particularly, to an NPU device that performs a convolution operation based on the number of channels of an input feature map and an output feature map, and an operating method thereof.

### 2. Description of the Related Art

A neural network refers to a computational architecture that models a biological brain. Recently, with the development of neural network technology, various kinds of electronic systems have been actively studied for analyzing input data and extracting valid information using a neural network device using more than one neural network model.

A neural network device is required to perform a large number of operations with complex input data. Therefore, in order for the neural network device to analyze a high-quality input in real time and extract information, technology capable of efficiently processing neural network operations is required.

That is, because a neural network device needs to perform an operation on complex input data, there is a need for a method and a device for effectively extracting data required for operations from complex and enormous input data using fewer resources and minimal power consumption.

### SUMMARY

The disclosure provides a Neural Processing Unit (NPU) device for performing an efficient convolution operation when the number of channels in an input feature map and an output feature map is small.

According to an aspect of an inventive concept of the disclosure, there is provided a method of generating an output feature map based on an input feature map, the method including: generating an input feature map vector for a plurality of input feature map blocks based on a number of channels of the input feature map being less than a number of reference channels; performing a convolution operation between the input feature map vector and weight maps, including one or more target weight maps and an additional weight map that has a weight identical to one of the one or more target weight maps, based on a number of the one or more target weight maps being less than a reference number; and generating an output feature map based on the convolution operation.

According to another aspect of an inventive concept of the disclosure, there is provided a Neural Processing Unit. The NPU device may include a vector generator configured to generate an input feature map vector for a plurality of input feature map blocks based on a number of channels of an input feature map being less than a number of reference channels; and a calculation circuit configured to: perform a convolution operation between the input feature map vector and weight maps, including one or more target weight maps and an additional weight map having a weight identical to one of the one or more target weight maps, based on a number of the one or more target weight maps being less than a reference number, and generate an output feature map based on a result of the convolution operation.

According to another aspect of an inventive concept of the disclosure, there is provided an operating method of the NPU device that performs a convolution operation based on convolution operation scheduling, the operating method including: adjusting the convolution operation scheduling based on at least one of a number of channels of an input feature map and a number of channels of an output feature map being less than a number of reference channels; performing a convolution operation of a weight map on the input feature map based on the adjusted convolution operation scheduling; and generating the output feature map based on the convolution operation.

According to another aspect of an inventive concept of the disclosure, there is provided a Neural Processing Unit (NPU) device including: a memory storing one or more instructions; and a processor configured to execute the one or more instructions to: determine whether a number of channels of an input feature map is less than a number of reference channels; generate an input feature map vector based on the number of channels of the input feature map being less than the number of reference channels; determine whether a number of target maps is less than a number of available channels of an output feature map; generate an additional weight map having a weight identical to one of the target weight maps, based on the number of target maps being less than the number of available channels of the output feature map; and perform a convolution operation on the input feature map vector with the target weight maps and the additional weight map to generate the output feature map.

### BRIEF DESCRIPTION OF THE DRAWINGS

Embodiments of the inventive concept will be more clearly understood from the following detailed description taken in conjunction with the accompanying drawings in which:

FIG. 1 is a block diagram of components of an NPU device according to an example embodiment;

FIGS. 2 and 3 are views of a structure of a convolutional neural network according to an example embodiment;

FIG. 4 is a view for describing a convolution operation according to an example embodiment;

FIG. 5 is a flowchart illustrating an operating method of an NPU device according to an example embodiment;

FIG. 6 is a view of channels of an input feature map for a plurality of available channels according to an example embodiment;

FIG. 7 is a block diagram of a configuration of generating an output feature map by generating an input feature map vector according to an example embodiment;

FIG. 8 is a view of a plurality of input feature map blocks corresponding to a weight map of a 3D structure according to an example embodiment;

FIG. 9 is a view of an input feature map vector generated based on a plurality of input feature map blocks according to an example embodiment;

FIGS. 10 and 11 are views of a weight map and a weight map vector according to an example embodiment;

FIG. 12 is a block diagram of an example in which an input feature map vector is generated by two of a plurality of vector generators;

FIG. 13 is a view illustrating an input feature map including a plurality of input feature map blocks according to another example embodiment;

FIG. 14 is a view of an input feature map vector generated based on a plurality of input feature map blocks according to the embodiment of FIG. 13;

FIG. 15 is a view of an output feature map generated by performing a convolution operation using a plurality of target weight maps according to an example embodiment;

FIG. 16 is a block diagram of a configuration of generating an output feature map based on an additional weight map according to an example embodiment;

FIG. 17 is a view of weight map sets including additional weight maps generated according to an example embodiment;

FIG. 18 is a view of an output feature map generated by a weight map set including additional weight maps;

FIG. 19 is a view of an input feature map including a plurality of input feature map blocks when a depth-wise convolution operation is performed;

FIG. 20 is a view of a configuration of a calculation circuit of a comparative example for performing a depth-wise convolution operation;

FIG. 21 is a block diagram of a configuration of generating an output feature map based on an additional weight map according to an example embodiment;

FIG. 22 is a view of an input feature map vector generated based on an identical channel area from among a plurality of input feature map blocks when a depth-wise convolution operation is performed; and

FIG. 23 is a view of a plurality of calculation circuits that perform a depth-wise convolution operation according to the embodiment of FIG. 21.

### DETAILED DESCRIPTION OF THE EMBODIMENTS

Hereinafter, embodiments of the inventive concept will be described in detail with reference to the accompanying drawings.

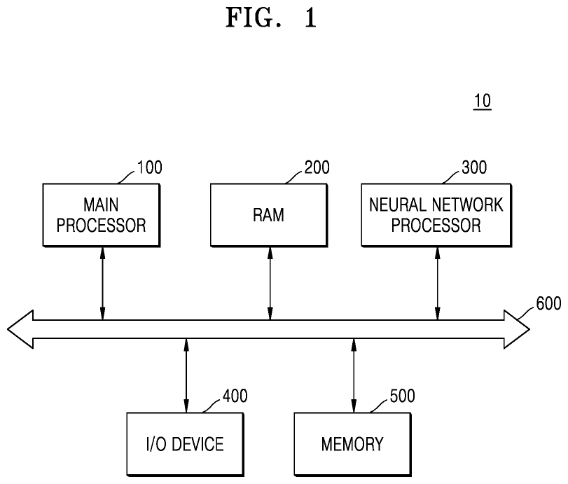

FIG. 1 is a block diagram of components of an Neural Processing Unit (NPU) device according to an example embodiment.

Referring to FIG. 1, an NPU device 10 may analyze input data in real time based on a neural network to extract valid information, determine a situation based on the extracted information, or control configurations of an electronic device in which the NPU device 10 is mounted. According to an example embodiment, the NPU device 10 may identify a situation based on the extracted information. For example, the NPU device 10 may be applied to a drone, an advanced drivers assistance system (ADAS), a smart TV, a smart phone, a medical device, a mobile device, a video display device, a measurement device, an Internet of Things (IoT) device, or the like, and may be mounted on one of various types of electronic devices. However, the disclosure is not limited thereto, and as such, the NPU device 10 may incorporated with any type electronic device. According to another example embodiment, the NPU device may be implemented as a stand-alone device.

The NPU device 10 may include at least one intellectual property (IP) block and a neural network processor 300. The NPU device 10 may include various types of IP blocks. For example, as shown in FIG. 1, the IP block may include a main processor 100, random access memory (RAM) 200, an input/output (I/O) device 400, and a memory 500. In addition, the NPU device 10 may further include other general-purpose components such as a multi-format codec (MFC), a video module (e.g., a camera interface, a joint photographic experts group (JPEG) processor, a video processor, or a mixer), a 3D graphics core, an audio system, a display driver, a graphic processing unit (GPU), a digital signal processor (DSP), and the like.

Configurations of the NPU device 10, for example, the main processor 100, the RAM 200, the neural network processor 300, the input/output device 400, and the memory 500 may transmit and receive data through a system bus 600. For example, an advanced microcontroller bus architecture (AMBA) protocol of Advanced RISC Machine (ARM) may be applied to the system bus 600 as a standard bus specification. However, the inventive concept is not limited thereto and various types of protocols may be applied.

According to an example embodiment, the components of the NPU device 10, including the main processor 100, the RAM 200, the neural network processor 300, the input/output device 400, and the memory 500 are implemented as a single semiconductor chip. For example, the NPU device 10 may be implemented as a system on a chip (SoC). However, the inventive concept is not limited thereto, and the NPU device 10 may be implemented with a plurality of semiconductor chips. In an embodiment, the NPU device 10 may be implemented as an application processor mounted on a mobile device.

The main processor 100 may control all operations of the NPU device 10, and as an example, the main processor 100 may be a central processing unit (CPU). The main processor 100 may include a single core or may include a multi-core. The main processor 100 may process or execute programs and/or data stored in the RAM 200 and the memory 500. For example, the main processor 100 may control various functions of the NPU device 10 by executing programs stored in the memory 500.

The RAM 200 may temporarily store programs, data, or instructions. For example, the programs and/or data stored in the memory 500 may be temporarily loaded into the RAM 200 according to control of the main processor 100 or boot code. The RAM 200 may be implemented using a memory such as dynamic RAM (DRAM) or static RAM (SRAM).

The input/output device 400 may receive input data from a user or an external device, and may output a data processing result of the NPU device 10. The input/output device 400 may be implemented using at least one of a touch screen panel, a keyboard, and various types of sensors. According to an embodiment, the input/output device 400 may collect information around the NPU device 10. For example, the input/output device 400 may include at least one of various types of sensing devices such as an imaging device, an image sensor, a light detection and ranging (LIDAR) sensor, an ultrasonic sensor, and an infrared sensor, or may receive a sensing signal from the device. In an embodiment, the input/output device 400 may sense or receive an image signal from outside the NPU device 10, and may convert the sensed or received image signal into image data, that is, an image frame. The input/output device 400 may store the image frame in the memory 500 or may provide the image frame to the neural network processor 300.

The memory 500 is a storage area for storing data, and may store, for example, an operating system (OS), various programs, and various data. The memory 500 may be DRAM, but is not limited thereto. The memory 500 may include at least one of a volatile memory and a non-volatile memory. The non-volatile memory may include read only memory (ROM), programmable ROM (PROM), electrically programmable ROM (EPROM), electrically erasable and programmable ROM (EEPROM), a flash memory, phase-change RAM (PRAM), magnetic RAM (MRAM), resistive RAM (RRAM), or ferroelectric RAM (FRAM). The volatile memory may include DRAM, SRAM, synchronous DRAM (SDRAM), or PRAM. Furthermore, in an embodiment, a memory 150 may be implemented as a storage device such as a hard disk drive (HDD), a solid state drive (SSD), compact flash (CF), secure digital (SD), micro secure digital (Micro-SD), mini secure digital (Mini-SD), extreme digital (xD), or a memory stick.

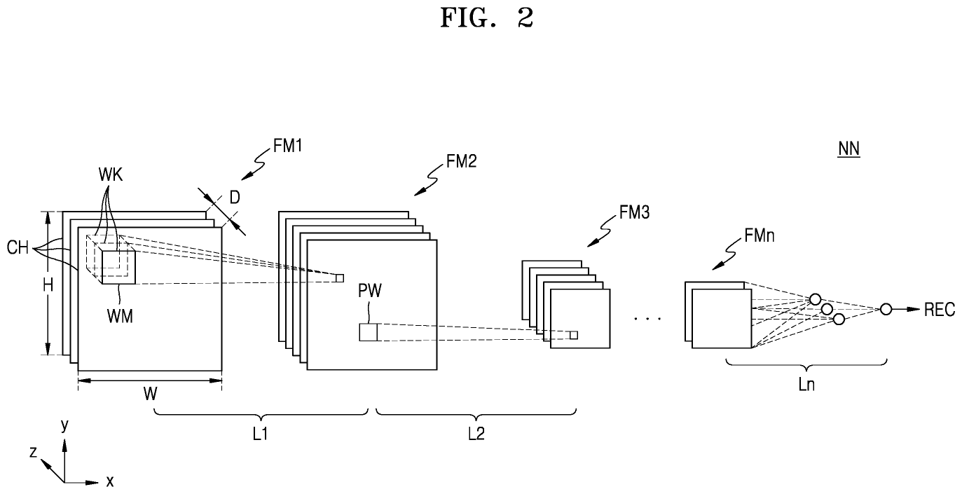

The neural network processor 300 may generate a neural network, may train or learn a neural network, may perform an operation based on received input data, may generate an information signal based on a result of the operation, and may retrain the neural network. The neural network may include various types of neural network models, such as a convolution neural network (CNN), a region with CNN (R-CNN), a region proposal network (RPN), a recurrent neural network (RNN), a stacking-based deep neural network (S-DNN), a state-space dynamic neural network (S-SDNN), a deconvolution network, a deep belief network (DBN), a restricted Boltzmann machine (RBM), a fully convolutional network, a long short-term memory (LSTM) network, and a classification network, but is not limited thereto. A neural network structure will be exemplarily described with reference to FIG. 2.

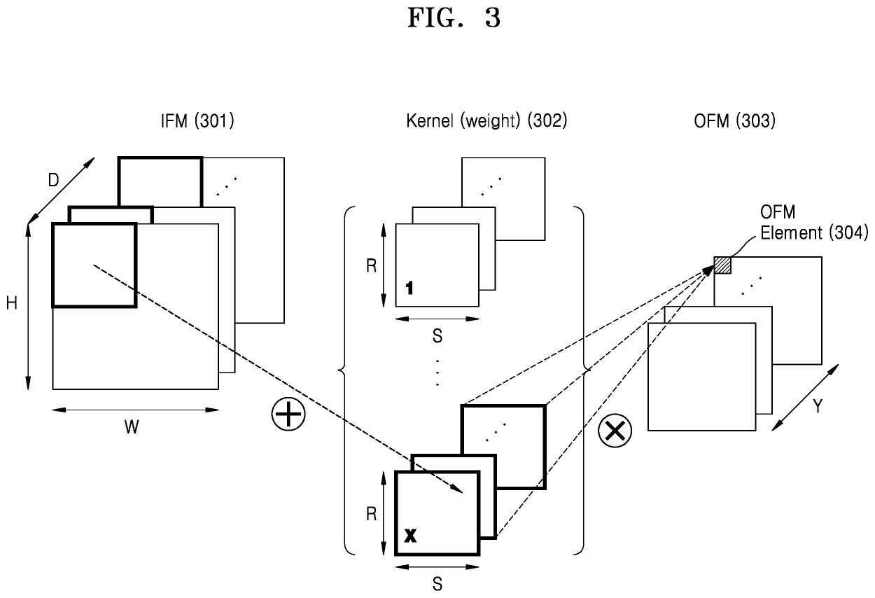

FIGS. 2 and 3 are views of a structure of a convolutional neural network according to an example embodiment.

Referring to FIG. 2, a neural network NN may include a plurality of layers L1 to Ln. The neural network NN may be an architecture of a deep neural network DNN or p-layers neural networks. The plurality of layers L1 to Ln may be implemented as a convolution layer, a pooling layer, an activation layer, and a fully connected layer.

For example, the first layer L1 may be a convolution layer, the second layer L2 may be a pooling layer, and an n^{th} layer Ln is an output layer and may be a fully connected layer. The neural network NN may further include an activation layer, and may further include a layer that performs other types of operations.

Each of the plurality of layers L1 to Ln may receive input data (e.g., image frame) or a feature map generated in a previous layer as an input feature map, and may generate an output feature map or a recognition signal REC by calculating the input feature map. In this case, the feature map refers to data in which various features of the input data are expressed. Feature maps FM1, FM2, and FMn may have, for example, a 2D matrix or a 3D matrix (or tensor) structure. The feature maps FM1, FM2, and FMn may include at least one channel CH in which feature values are arranged in a matrix. When the feature maps FM1, FM2, and FMn include a plurality of channels CH, the number of rows H and the number of columns W of the plurality of channels CH are the same. In this case, the row H, column W, and channel CH may correspond to x-axis, y-axis, and z-axis of the coordinates, respectively. Feature values arranged in a specific row H and column W in a 2D matrix in x-axis and y-axis directions (hereinafter, the matrix in the disclosure means a 2D matrix in the x-axis and y-axis directions) may be referred to as elements of the matrix. For example, a 4×5 matrix structure may include 20 elements.

The first layer L1 may generate the second feature map FM2 by convolving the first feature map FM1 with a weighted kernel WK. The weighted kernel WK may be referred to as a filter, a weight map, or the like. The weighted kernel WK may filter the first feature map FM1. A structure of the weighted kernel WK is similar to that of the feature map. The weighted kernel WK includes at least one channel CH in which weights are arranged in a matrix. Moreover, the number of channels CH of the weighted kernel WK may be the same as the number of channels CH of a corresponding feature map, for example, the first feature map FM1. The same channels CH of the weighted kernel WK and the first feature map FM1 may be convolved. For instance, a first channel CH of the weighted kernel WK and a corresponding first channel CH of the first feature map FM1 may be convolved. Hereinafter, the weighted kernel WK may be referred to as a weight map. When the second feature map FM2 is generated by convolving the first feature map FM1 with the weight map, the first feature map FM1 may be referred to as an input feature map, and the second feature map FM2 may be referred to as an output feature map.

While the weighted kernel WK shifts the first feature map FM1 in a sliding window manner, the weighted kernel WK may be convolved with windows (or tiles) of the first feature map FM1. During each shift, each weight included in the weighted kernel WK may be multiplied and added to all feature values in an area overlapping the first feature map FM1. As the first feature map FM1 and the weighted kernel WK are convolved, one channel of the second feature map FM2 may be generated. Although one weighted kernel WK is shown in FIG. 2, a plurality of weighted kernels WK may be convolved with the first feature map FM1 to generate the second feature map FM2 including a plurality of channels.

A neural network according to an example embodiment may be a segmentation network such as DeepLabV3, and the NPU device 10 may perform a decoding operation to recreate an image after an encoding operation. In this case, when performing the decoding operation, the NPU device 10 may receive an input feature map for some of available channels or may generate an output feature map for some of the channels. For example, the NPU device 10 may perform a convolution operation using only 4 channels of 32 available channels.

Referring to FIG. 3, input feature maps (IFM) 301 may include D channels, and an input feature map of each channel may have a size of H rows and W columns (D, H, and W are natural numbers). Each of kernels 302 has a size of R rows and S columns, and the kernel 302 may include a number of channels corresponding to the number of channels (or depth) D of the input feature maps 301 (R and S are natural numbers). Output feature maps (OFM) 303 may be generated through a 3D convolution operation between the input feature maps 301 and the kernels 302, and may include Y channels according to the convolution operation. Y may correspond to the number of kernels that perform convolution operations. The output feature maps (OFM) 303 may include a plurality of output feature elements 304.

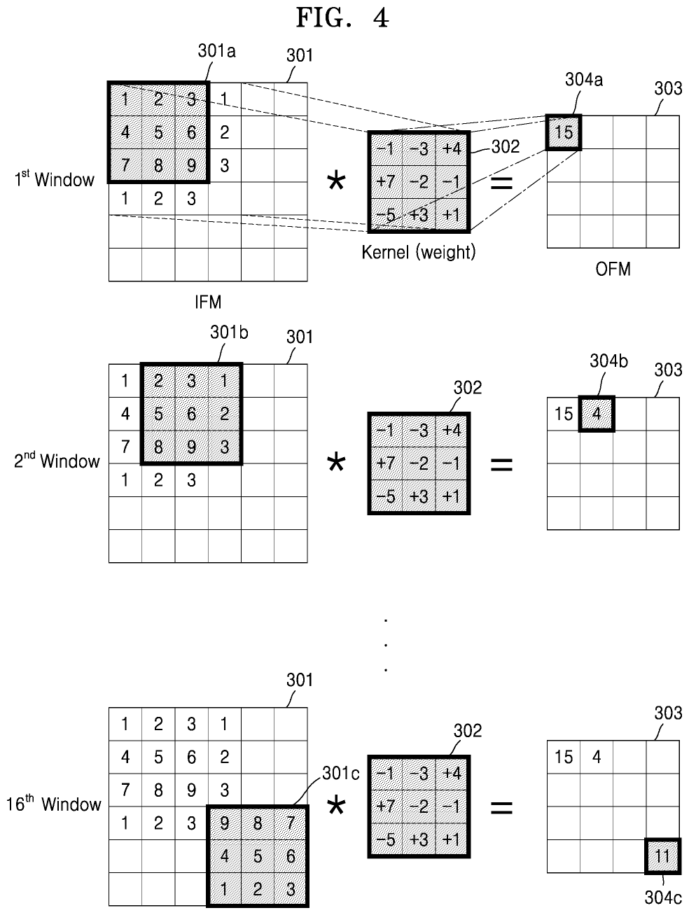

A process of generating an output feature map through a convolution operation between one input feature map and one kernel may be described with reference to FIG. 4. A 2D convolution operation described in FIG. 4 is performed between the input feature maps 301 of all channels and the kernels 302 of all channels, so that the output feature maps 303 of all channels may be generated.

FIG. 4 is a view for describing a convolution operation according to an example embodiment.

Referring to FIG. 4, for convenience of explanation, it is assumed that the input feature map 301 has a size of 6×6, the kernel 302 has a size of 3×3, and the output feature map 303 has a size of 4×4, but the inventive concept is not limited thereto. The neural network may be implemented with feature maps and kernels of various sizes. In addition, values defined in the input feature map 301, the kernel 302, and the output feature map 303 are all exemplary values, and embodiments of the disclosure are not limited thereto.

The kernel 302 may perform a convolution operation while sliding in a 3×3 window unit in the input feature map 301. The convolution operation may represent an operation for obtaining each feature data of the output feature map 303 by summing all values that are obtained by multiplying each feature data of a window of the input feature map 301 and each weight at a location corresponding to the kernel 302. Data included in the window of the input feature map 301 that is multiplied by the weights may be referred to as extracted data extracted from the input feature map 301. In more detail, the kernel 302 may first perform a convolution operation with first extracted data 301a of the input feature map 301. That is, feature data 1, 2, 3, 4, 5, 6, 7, 8, and 9 of the first extracted data 301a are multiplied by −1, −3, 4, 7, −2, −1, −5, 3, and 1 that are respectively corresponding weights of the kernel 302. As a result, −1, −6, 12, 28, −10, −6, −35, 24, and 9 may be obtained. Next, −1, −6, 12, 28, −10, −6, −35, 24, and 9 are added to produce 15, which is a result of adding all the obtained values −1, −6, 12, 28, −10, −6, −35, 24, 9. As such, a feature element 304a of a first row and a first column in the output feature map 303 may be determined as 15. Here, the feature elements 304a of the first row and first column in the output feature map 303 correspond to the first extracted data 301a. In the same way, by performing a convolution operation between second extracted data 301b of the input feature map 301 and the original kernel 302, 4, a feature element 304b of the first row and second column of the output feature map 303 may be determined. Finally, by performing a convolution operation between 16^{th} extracted data 301c, which is the last extracted data of the input feature map 301, 11, a feature element 304c of fourth row and fourth column of the output feature map 303 may be determined.

In other words, a convolution operation between one input feature map 301 and one kernel 302 may be processed by repeatedly performing multiplication of extracted data of the input feature map 301 and corresponding weights of the original kernel 302 and the summation of the multiplication results, and the output feature map 303 may be generated because of the convolution operation.

FIG. 4 illustrates a convolution operation for the input feature map 301 of a 2D structure. However, the input feature map 301 according to an example embodiment has a 3D structure, and the NPU device 10 performs a convolution operation on the input feature map 301 and the kernel 302 corresponding to an identical channel, thereby providing the output feature map 303 for the input feature map 301 having a 3D structure including a plurality of channels. In addition, the NPU device 10 may output one output feature map 303 by performing a convolution operation on one kernel 302 and the input feature map 301. However, the NPU device 10 may output one output feature map 303 by performing a convolution operation a plurality of kernels 302 and the input feature map 301. Here when there are a plurality of kernels 302, the number of channels of the output feature map 303 may correspond to the number of kernels.

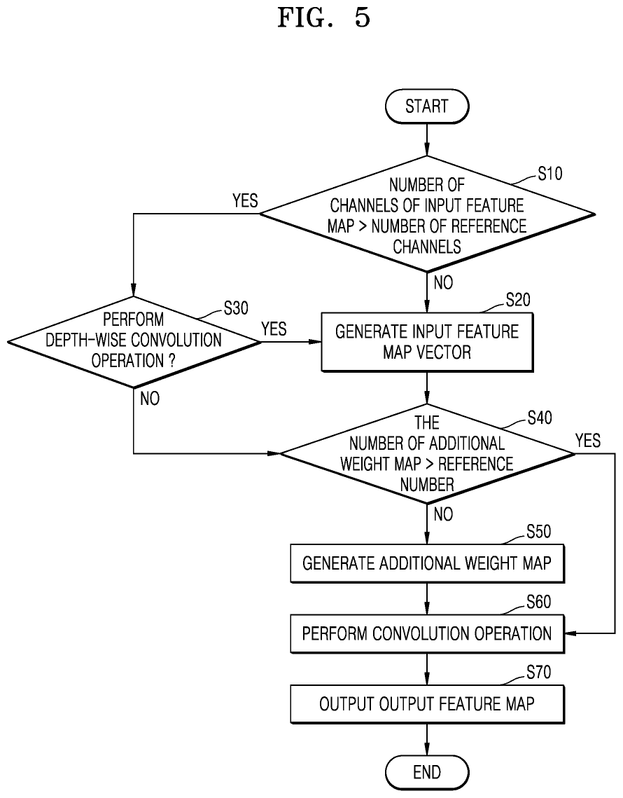

FIG. 5 is a flowchart illustrating an operating method of the NPU device 10 according to an example embodiment.

Referring to FIG. 5, when the number of channels in an input feature map is less than a certain number of reference channels, when the NPU device 10 performs a depth-wise convolution operation, and when the number of channels in an output feature map is less than a reference number because the target weight map number is less than the reference number, the NPU device 10 may perform a convolution operation using as many available channels as possible by generating an input feature map vector or an additional weight map. The number of reference channels and the reference number may be preset numbers.

In operation S10, the NPU device 10 may compare the number of channels of the input feature map and the number of reference channels. In operation S20, when the number of channels of the input feature map is less than or equal to the number of reference channels, an input feature map vector may be generated. The NPU device 10 according to an example embodiment may determine whether to generate an input feature map vector in a corresponding layer based on a result of comparing the number of reference channels and the number of channels of the input feature map, but the disclosure is not limited thereto. As such, according to another example embodiment, a layer to perform a convolution operation may be set by generating an input feature map vector.

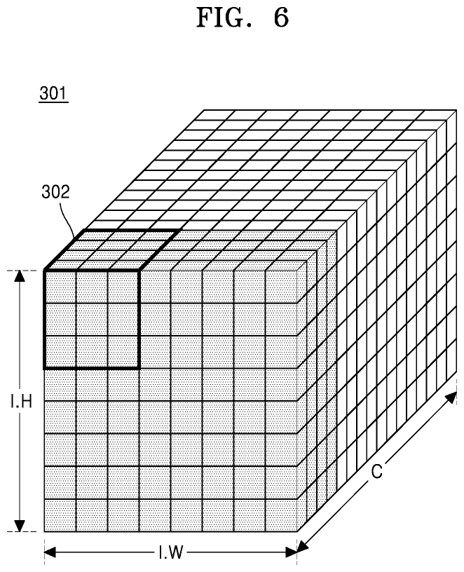

In operation S30, the NPU device 10 may determine whether to perform a depth-wise convolution operation, and may generate an input feature map vector in operation S20 based on a determination to perform a depth-wise convolution operation. The input feature map vector may be a vector generated by connecting at least some of a plurality of input feature map blocks, and an input feature map block may include an element corresponding to at least one input value. For example, the input feature map vector may be a vector generated by connecting all of the plurality of input feature map blocks, or may be a vector generated by connecting some of input feature map blocks in an identical channel area from among the plurality of input feature map blocks. An embodiment of generating an input feature map vector will be described in detail later with reference to FIGS. 6 to 18.

In operation S40, the NPU device 10 may determine whether to generate an additional weight map. For example, the NPU device 10 may determine whether the number of weight maps is greater than the reference number. In operation S50, when the number of weight maps is greater than the reference number, the NPU device 10 may generate at least one additional weight map that has a weight identical to that of the target weight map. Referring to FIG. 4, the number of weight maps may be the number of kernels that perform a convolution operation on an input feature map, and the number of weight maps may correspond to the number of channels of an output feature map. The NPU device 10 according to an example embodiment may determine whether to generate an additional weight map in a corresponding layer based on a result of comparing the number of weight maps and the reference number, but the disclosure is not limited thereto. As such, according to another example embodiment, a layer to perform a convolution operation may be set by generating an additional weight map.

In operation S60, when generating an input feature map vector, the NPU device 10 may perform a convolution operation with a plurality of weight maps. In more detail, the NPU device 10 may generate a weight map vector from a weight map by a method of generating an input feature map vector from an input feature map, and may perform a dot product operation on the input feature map vector and the weight map vector.

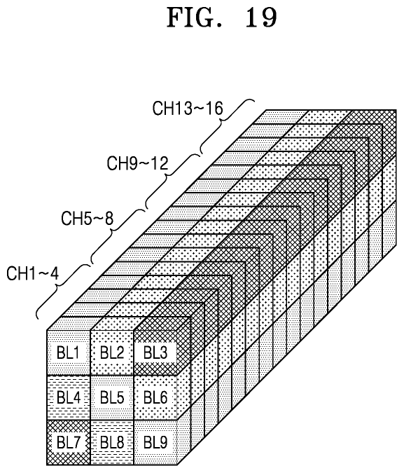

When the NPU device 10 generates an additional weight map, the NPU device 10 may perform a convolution operation with a target weight map and the additional weight map on the input feature map or the input feature map vector. For example, when the NPU device 10 generates an input feature map vector, the NPU device 10 may perform a convolution operation with a weight map vector based on a target weight map and an additional weight map on the input feature map vector. However, when the NPU device 10 does not generate an input feature map vector, the NPU device 10 may perform a convolution operation with the target weight map and the additional weight map on the input feature map. An embodiment in which the NPU device 10 generates an additional weight map to perform a convolution operation will be described later with reference to FIGS. 19 to 22.

In operation S70, the NPU device 10 may generate a result of performing the convolution operation with an element of an output feature map, and may generate an output feature map with a plurality of output feature map elements. Channels of the output feature map may be configured as many as the number of weight maps, and when the NPU device 10 generates an additional weight map, the NPU device 10 may output an output feature map including more channels than the number of target weight maps.

FIG. 6 is a view of channels of an input feature map for a plurality of available channels according to an example embodiment.

Referring to FIG. 6, the NPU device 10 of the inventive concept may generate the input feature map 301 including a plurality of channels to perform a convolution operation. The input feature map 301 may be an output feature map output from another layer, and the NPU device 10 may perform a convolution operation using an output feature map output from another layer as the input feature map 301. However, the disclosure is not limited thereto, and as such, the input feature map 301 may not be from a previous layer. The NPU device 10 may secure a hardware space or hardware resources for performing a convolution operation as an available channel C, and may perform a neural network operation most efficiently when performing a convolution operation on the input feature map 301 using the entire available channel C. For instance, the NPU device 100 may allocate hardware resources for performing a convolution operation as an available channel C, and may perform a neural network operation most efficiently when performing a convolution operation on the input feature map 301 using the entire available channel C. According to the embodiment of FIG. 6, although the NPU device 10 secures 16 channels as available channels C, the NPU device 10 performs an operation on an input feature map including 4 channels, and thus may perform a convolution operation at 25% of the maximum performance.

The NPU device 10 may load a weight map 302 having a 3D structure having a number of channels corresponding to the input feature map 301 to perform a convolution operation on the input feature map 301 including limited channels from among the available channels C. The NPU device 10 may perform a convolution operation on some elements of the weight map 302 and the input feature map 301 to generate an output value corresponding to one element in the output feature map. Referring to FIG. 6, an input feature map including 4 channels may include 256 (8*8*4) elements, and the NPU device 10 may perform a convolution operation on 36 (3*3*4) elements corresponding to the weight map 302 from among 256 (8*8*4) elements to generate one output feature map element. In this case, the NPU device 10 may perform a convolution operation on one input feature map block in one cycle. The input feature map block may be an element line formed in a channel direction, and the number of elements included in the input feature map block may correspond to the number of channels of the input feature map. Referring to the embodiment of FIG. 6, an element line in a channel direction formed in each row and each column may be one input feature map block. The NPU device 10 may perform a vector dot product operation for nine cycles to generate one output feature map element based on the weight map 302 including three rows and three columns.

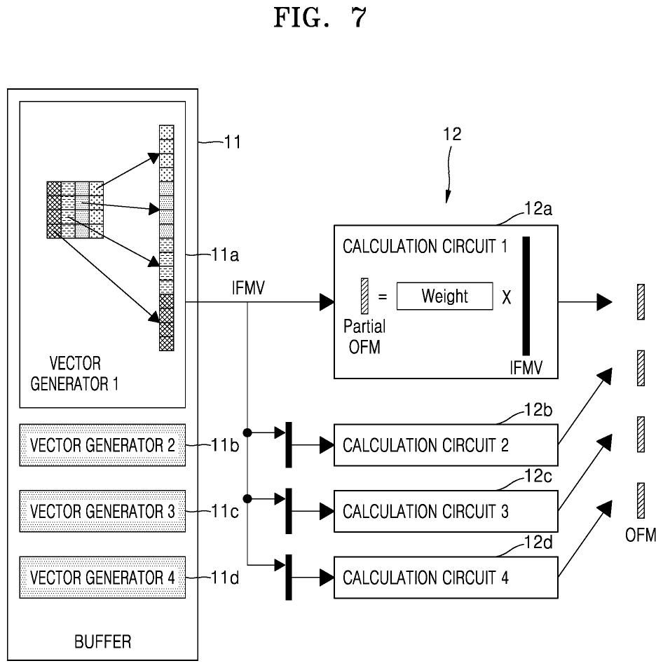

When the input feature map 301 is configured with a limited channel, the NPU device 10 according to an example embodiment may generate an input feature map vector based on input feature map blocks, and may generate an output feature map using as many channels as possible by performing a convolution operation on an input feature map vector. Accordingly, the NPU device 10 according to an example embodiment may generate an output feature map by performing a convolution operation in fewer cycles than when a convolution operation is performed on the input feature map 301 configured with a limited channel. Hereinafter, an embodiment in which the NPU device 10 generates an output feature map for an input feature map configured with a limited channel will be described with reference to FIGS. 7 to 14.

FIG. 7 is a block diagram of a configuration of generating an output feature map by generating an input feature map vector according to an embodiment.

Referring to FIG. 7, the NPU device 10 may include a buffer, and the buffer may include a plurality of vector generators 11 that generate an input feature map vector IFMV for the generated input feature map. The NPU device 10 may determine whether to activate the plurality of vector generators 11 based on the number of channels of the input feature map. For example, the NPU device 10 may determine a vector generator 11 to be activated based on a ratio of the number of channels of the input feature map to the number of available channels. Referring to FIG. 7, when the number of available channels is 16 and the number of channels of the input feature map is 4, the NPU device 10 may activate a first vector generator 11a of the four vector generators 11. The first vector generator 11a may generate the input feature map vector IFMV based on an input feature map block corresponding to a first channel to a fourth channel from among a plurality of input feature map blocks.

According to an example embodiment, a plurality of calculation circuits 12 may receive an input feature map vector IFMV from the vector generator 11, and may perform a convolution operation on a weight map corresponding to each calculation circuit 12 and the broadcasted input feature map vector IFMV. The calculation circuits may include an arithmetic circuit or an accumulator circuit. For example, a first calculation circuit 12a may receive a first input feature map vector IFMV1 generated from the first vector generator 11a, and may generate an output feature map by performing a convolution operation on the first input feature map vector IFMV1 and a weight map. The number of channels of the generated output feature map may be determined according to the first input feature map vector IFMV1 and the number of weight maps on which the convolution operation is performed.

The NPU device 10 may include a plurality of calculation circuits 12, and each of the calculation circuits 12 may generate a plurality of output feature maps by performing a convolution operation in parallel. Referring to FIG. 7, the NPU device 10 may include four calculation circuits 12, and each of the calculation circuits 12 may generate four output feature maps by performing a convolution operation based on different weight maps. In addition, each of the calculation circuits 12 may generate a plurality of output feature maps in parallel based on the plurality of weight maps. For example, the first calculation circuit 12a may generate a first output feature map to a fourth output feature map based on a first weight map to a fourth weight map, and in this way, the four calculation circuits 12 may generate 16 output feature maps.

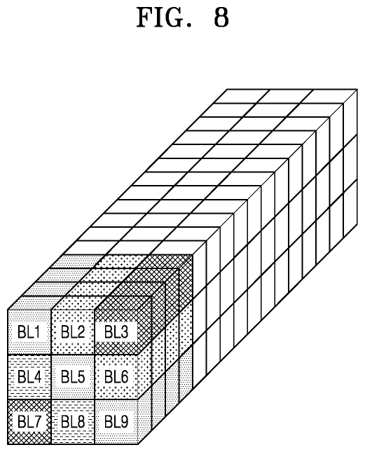

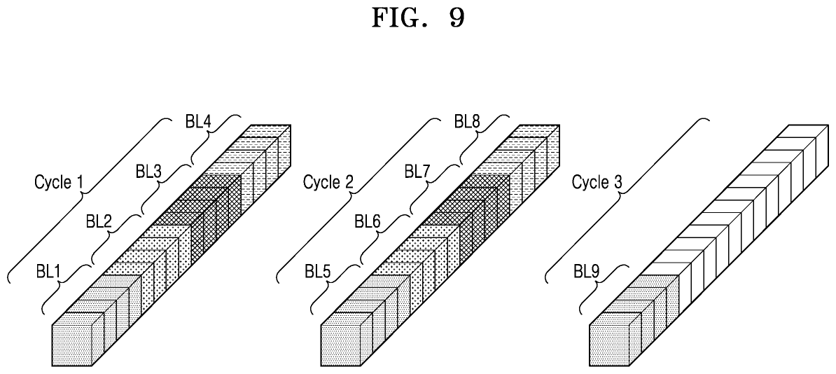

FIG. 8 is a view of a plurality of input feature map blocks BL corresponding to a weight map of a 3D structure according to an example embodiment, and FIG. 9 is a view of the input feature map vector IFMV generated based on the plurality of input feature map blocks BL according to an example embodiment.

FIG. 8 illustrates only a portion of an input feature map in which a convolution operation is performed to generate one output feature map element. The input feature map may include the plurality of input feature map blocks BL, and an input feature map block BL may be an element line in a channel direction including at least one input feature map element. The number of elements included in one input feature map block BL may correspond to the number of channels of the input feature map. The NPU device 10 according to a comparative embodiment of FIG. 6 may perform a convolution operation on one input feature map block BL in one cycle, and may generate one output feature map element because of performing the convolution operation for nine cycles.

Referring to FIG. 9, the NPU device 10 according to an embodiment may generate the plurality of input feature map blocks BL as one input feature map vector IFMV. For example, when nine input feature map blocks BL1 to BL9 are required to generate one output feature map element, the NPU device 10 may generate one input feature map vector IFMV by combining the nine input feature map blocks BL1 to BL9 to each other. The NPU device 10 may perform a convolution operation on elements corresponding to the number of available channels in the generated input feature map vector IFMV for one cycle. According to the embodiment of FIG. 9, the NPU device 10 may perform a convolution operation on the four input feature map blocks BL1 to BL4 for one cycle, and may perform a convolution operation for 3 cycles to perform a convolution operation on the nine input feature map blocks BL1 to BL9.

According to a comparative example, hardware of the NPU device 10 has the capability to perform a convolution operation corresponding to the number of available channels for one cycle, but when the number of channels of an input feature map is limited, the NPU device 10 may perform convolution operations only on limited input feature map elements. Accordingly, it is necessary to perform convolution operations of many cycles to generate one output feature map element. According to an embodiment, when the number of channels in the input feature map is limited, the NPU device 10 may generate the input feature map vector IFMV to perform a convolution operation on the plurality of input feature map blocks BL in one cycle to efficiently perform a convolution operation on an available channel. Therefore, the NPU device 10 according to an embodiment may perform a convolution operation of fewer cycles to generate one output feature map element.

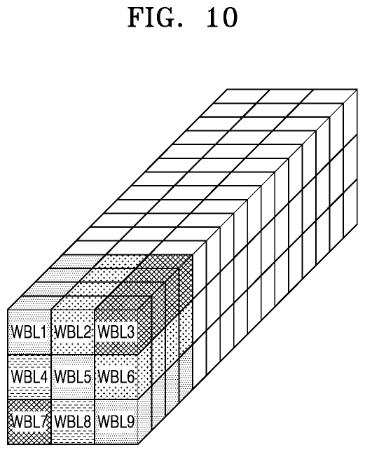

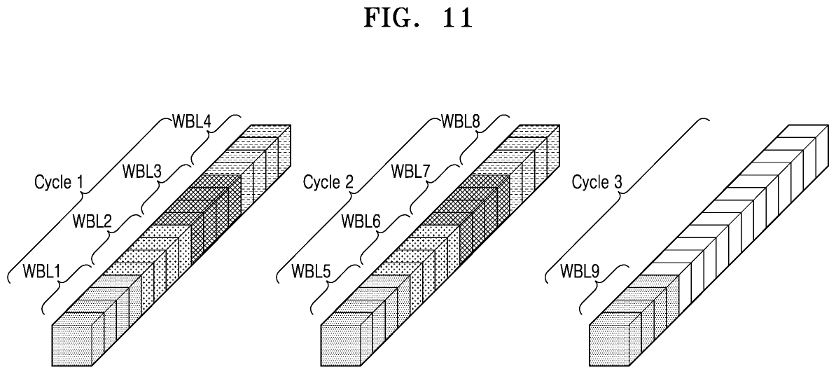

FIGS. 10 and 11 are views of a weight map and a weight map vector according to an embodiment.

Referring to FIG. 10, the weight map may include a plurality of weight map blocks WBL, and a size of the weight map may correspond to a size of an input feature map. An NPU device according to an embodiment may further include a weight vector generator that performs the same operation as that of the vector generator 11, and a weight vector generator may be configured with hardware the same as that of the vector generator 11 that generates an input feature map vector to generate the weight map vector, but is not limited thereto and may be configured with different hardware. The NPU device 10 may perform a convolution operation by multiplying an input feature map element and a weight map element at a corresponding position in an input feature map and a weight map having a 3D structure, and summing a result of the multiplying. As described above in FIG. 8, the NPU device 10 may perform a convolution operation on one input feature map block BL and one weight map block WBL for one cycle, and according to the embodiment of FIG. 10, may generate one output feature map element because of performing a convolution operation for nine cycles.

Referring to FIG. 11, the NPU device 10 may generate a weight map vector based on a weight map in the same manner as generating the input feature map vector IFMV to perform a convolution operation with the input feature map vector IFMV. For example, when the NPU device 10 combine the nine input feature map blocks BL1 to BL9 to each other to generate one input feature map vector IFMV, the NPU device 10 may generate one weight map vector by connecting nine weight map blocks WBL1 to WBL9 to each other in an order in which the input feature map blocks BL are connected to each other. The NPU device 10 may generate one output feature map element by performing a convolution operation for the nine input feature map blocks BL1 to BL9 and the 9 weight map blocks WBL1 to WBL9 for three cycles.

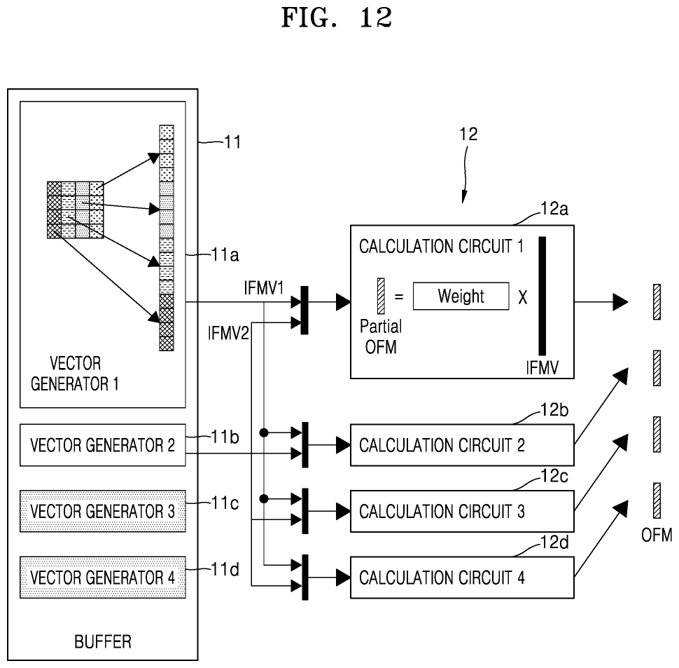

FIG. 12 is a block diagram of an example in which the input feature map vector IFMV is generated by two of the plurality of vector generators 11.

Referring to FIG. 12, the NPU device 10 may activate two or more of the plurality of vector generators 11 according to the number of channels of an input feature map. FIGS. 7 to 11 are example embodiments showing that the input feature map vector IFMV is generated by activating only one of the plurality of vector generators 11. However, according to an example embodiment illustrated in FIG. 12, two or more of the plurality of vector generators 11 may be activated to generate the input feature map vector IFMV. Each of the plurality of vector generators 11 may correspond to a channel area including some of the channels of the input feature map, and the NPU device 10 may determine whether to activate the corresponding vector generator 11 according to whether an input feature map element exists in the corresponding channel area. That is, the NPU device 10 may determine the vector generator 11 to be activated based on a ratio of the number of channels of the input feature map to the number of available channels. For example, in FIG. 12, the vector generator 11a and the vector generator 11b may be activated to generate the input feature map vector IFMV. For instance, the vector generator 11a may generate the input feature map vector IFMV1 and the vector generator 11b may generate the input feature map vector IFMV2. Thereafter, the input feature map vector IFMV1 and the input feature map vector IFMV2 may be combined to generate the input feature map vector IFMV. The vector generator 11 generating the input feature map vector IFMV and outputting the generated input feature map vector IFMV to the calculation circuits 12 has been described above with reference to FIG. 7, and thus a detailed description thereof will not be given herein.

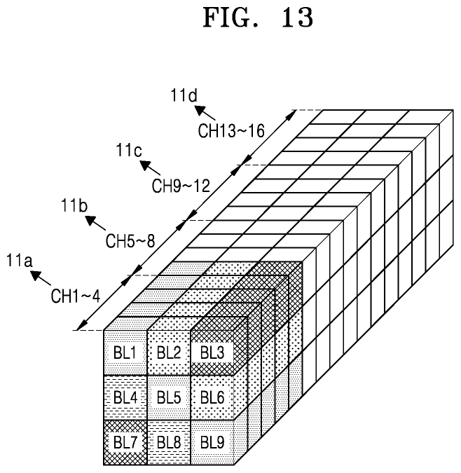

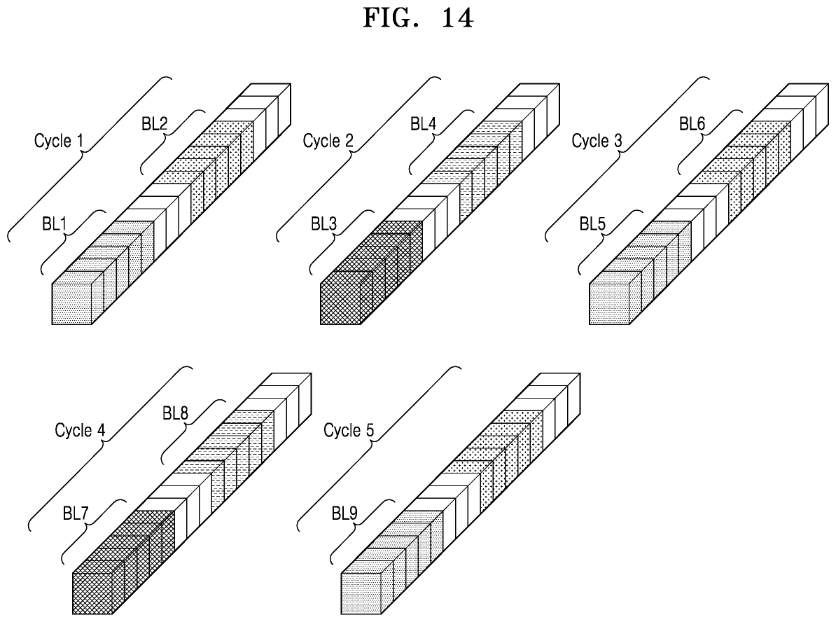

FIG. 13 is a view of an input feature map including the plurality of input feature map blocks BL according to an example embodiment different from that of FIG. 8, and FIG. 14 is a view of the input feature map vector IFMV generated based on the plurality of input feature map blocks BL according to the embodiment of FIG. 13.

Referring to FIGS. 12 and 13, when the number of available channels is 16 and the number of channels of the input feature map is 5, the NPU device 10 may activate the first vector generator 11a and a second vector generator 11b from among the four vector generators 11. Each of the four vector generators 11 may generate input feature map vectors IFMV1 to IFMV4 for a channel area of a corresponding input feature map. For example, in the input feature map according to FIG. 13, the first vector generator 11a may generate the first input feature map vector IFMV1 based on input feature map elements of first to fourth channels CH1 to CH4, and the second vector generator 11b may generate the second input feature map vector IFMV2 based on input feature map elements of fifth to eighth channels CH5 to CH8. The first vector generator 11a and the second vector generator 11b may broadcast the generated first input feature map vector IFMV1 and second input feature map vector IFMV2 to the plurality of calculation circuits 12.

The plurality of calculation circuits 12 may receive a plurality of input feature map vectors IFMV generated from the plurality of vector generators 11, and may generate the input feature map vector IFMV for performing a convolution operation by combining the plurality of input feature map vectors IFMV. Referring to FIG. 14, each of the plurality of calculation circuits 12 may combine the plurality of input feature map vectors IFMV in units of the input feature map block BL when receiving the plurality of input feature map vectors IFMV. For example, the input feature map vector IFMV may include partial input feature map vectors IFMV corresponding to the input feature map block BL, and may cross-link partial input feature map vectors IFMV generated by different vector generators 11.

According to the embodiments of FIGS. 13 and 14, the first vector generator 11a may generate the first input feature map vector IFMV1 based on the input feature map elements corresponding to the first to fourth channels CH1 to CH4 in the first to ninth input feature map blocks BL1 to BL9. In this case, the first vector generator 11a may generate a first partial input feature map vector based on input feature map elements corresponding to first to fourth channels of the first input feature map block BL, and may generate the second to ninth partial input feature map vectors in this manner.

According to an embodiment, when the calculation circuit 12 receives input feature map vectors IFMV including partial input feature map vectors from the plurality of vector generators 11, the calculation circuit 12 may combine the partial input feature map vectors in units of the input feature map block BL. For example, the calculation circuit 12 may perform a convolution operation by combining a partial input feature map vector corresponding to the first to fourth channels CH1 to CH4 in the first input feature map block BL1 received from the first vector generator 11a and a partial input feature map vector corresponding to the fifth to eighth channels CH5 to CH8 in the first input feature map block BL1 received from the second vector generator 11b and then combining a partial input feature map vector corresponding to the second input feature map block BL2. Accordingly, the calculation circuit 12 may perform a convolution operation based on the input feature map vectors IFMV generated by the plurality of vector generators 11.

However, the NPU device 10 according to an embodiment is not limited to combining the input feature map vectors IFMV received from the vector generators 11 in units of the input feature map block BL according to the embodiment of FIG. 14, but may combine the input feature map vectors IFMV in units of the vector generator 11. For example, the NPU device 10 may perform a convolution operation by connecting the second input feature map vector IFMV2 received from the second vector generator 11b to the first input feature map vector IFMV1 received from the first vector generator 11a. According to an example embodiment, because the number of channels of a weight map on which the convolution operation is to be performed corresponds to the number of channels of an input feature map, the NPU device 10 may also generate a weight map vector in the same manner as the method of generating the input feature map vector IFMV. Moreover, because a method of generating a weight map vector has been described above with reference to FIGS. 10 and 11, detailed descriptions will not be given herein.

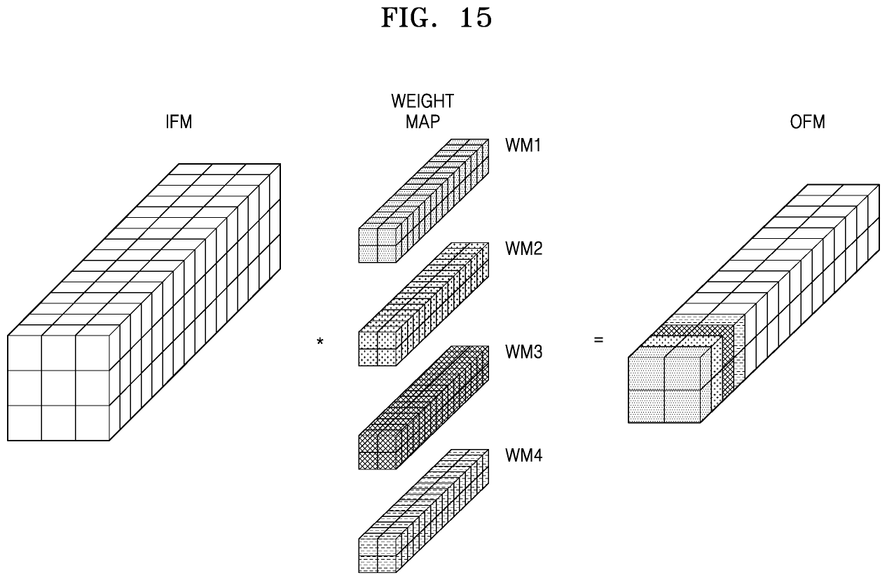

FIG. 15 is a view of an output feature map generated by performing a convolution operation using a plurality of target weight maps according to an example embodiment.

Referring to FIG. 15, the NPU device 10 may generate an output feature map having a number of channels corresponding to the number of the weight maps by performing a convolution operation on an input feature map and a plurality of weight maps WM1 to WM4. The NPU device 10 may generate an output feature map by performing a convolution operation between the input feature map with a weight map having the same number of channels as the input feature map. For example, the NPU device 10 may generate an output feature map having four channels by performing a convolution operation with four weight maps WM1 to WM4.

Hardware of the NPU device 10 according to an embodiment may perform enough calculation to generate output feature maps as many as the number of available channels. However, when the number of weight maps is limited, the NPU device 10 may generate an output feature map having fewer channels than the number of available channels. That is, in the embodiment according to FIG. 15, the hardware of the NPU device 10 may generate an output feature map having 16 channels based on 16 weight maps, but the NPU device 10 may generate an output feature map having 4 channels for the same time period by performing a convolution operation based on 4 weight maps. When the NPU device 10 performs a convolution operation based on four weight maps as in the embodiment of FIG. 15, because the NPU device 10 processes only 25% of the amount of calculation compared to the maximum performance, the convolution operation is performed inefficiently.

The NPU device 10 according to an embodiment may generate an additional weight map that has a weight identical to that of a target weight map, which is an existing weight map, and may efficiently utilize the hardware of the NPU device 10 by performing a convolution operation on input weight map blocks having different target weight maps and additional weight maps.

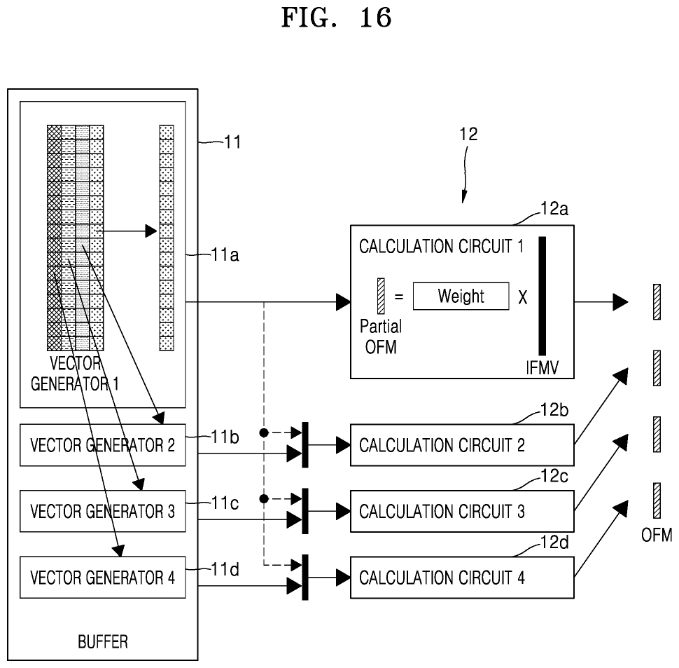

FIG. 16 is a block diagram of a configuration of generating an output feature map based on an additional weight map according to an embodiment.

Referring to FIG. 16, when a number of target weight maps is less than a reference number, the plurality of vector generators 11 included in a buffer of the NPU device 10 may provide different input feature map blocks BL to the calculation circuit 12 corresponding to one-to-one. When the vector generators 11 determine that the number of channels of an input feature map is greater than the number of reference channels, or determine that a depth-wise convolution operation is not performed, the vector generators 11 may not generate the input feature map vector IFMV by merging at least some of the plurality of input feature map blocks BL. In other words, the vector generators 11 may provide different input feature map blocks BL from among the input feature map blocks BL to the calculation circuit 12 corresponding to each vector generator 11. When the vector generators 11 determine that the number of channels of the input feature map is less than or equal to the number of reference channels or when the vector generators 11 determines to perform a depth-wise convolution operation, the vector generators 11 may generate input feature map vectors IFMV based on at least some of the plurality of input feature map blocks BL, and may provide the input feature map vectors IFMV to the calculation circuit 12.

According to a comparative example, the NPU device 10 may determine a calculation device to be activated from among a plurality of calculation devices based on the number of target weight maps. For example, each calculation circuit 12 may perform a convolution operation on a plurality of weight maps in parallel. Each calculation circuit 12 may perform a convolution operation on four weight maps, and when the number of target weight maps for which the convolution operation is to be performed in parallel is 4 or less, the NPU device 10 may activate any one of the four calculation circuits 12 to perform the convolution operation. That is, the NPU device 10 according to the comparative example deactivates the remaining three calculation circuits 12 and generates an output feature map by one calculation circuit 12, so that it may take up to four times as much time as compared to a case where all the calculation circuits 12 are activated.

According to an embodiment, the NPU device 10 may generate an output feature map using the calculation circuit 12 that is deactivated in the comparative example by generating at least one additional weight map that has a weight identical to that of a target weight map. The generated additional weight map may be distributed so that a convolution operation is performed in the calculation circuits 12 different from the calculation circuits 12 performing convolution operation of the target weight map, and input feature map blocks BL or input feature map vectors IFMV respectively transmitted from the plurality of vector generators 11 to the calculation circuits 12 may include different input feature map elements.

According to FIGS. 15 and 16, when the number of target weight maps is 4 and the number of available channels in the output feature map is 16, hardware of the NPU device 10 may be in a state capable of performing a convolution operation on 16 weight maps. The NPU device 10 may generate 12 additional weight maps by generating three additional weight maps each that has a weight identical to one of the 4 target weight maps. Accordingly, 16 weight maps including 3 additional weight maps and a target weight map may be allocated to each of the four calculation circuits 12, and the plurality of calculation circuits 12 may generate 16 output circuit map elements while the comparative embodiment generates 4 output circuit map elements based on the allocated weight maps. At this time, because the input feature map blocks BL or the input feature map vectors IFMV respectively received by the calculation circuits 12 are different from each other, the four calculation circuits 12 may generate 16 different output circuit map elements.

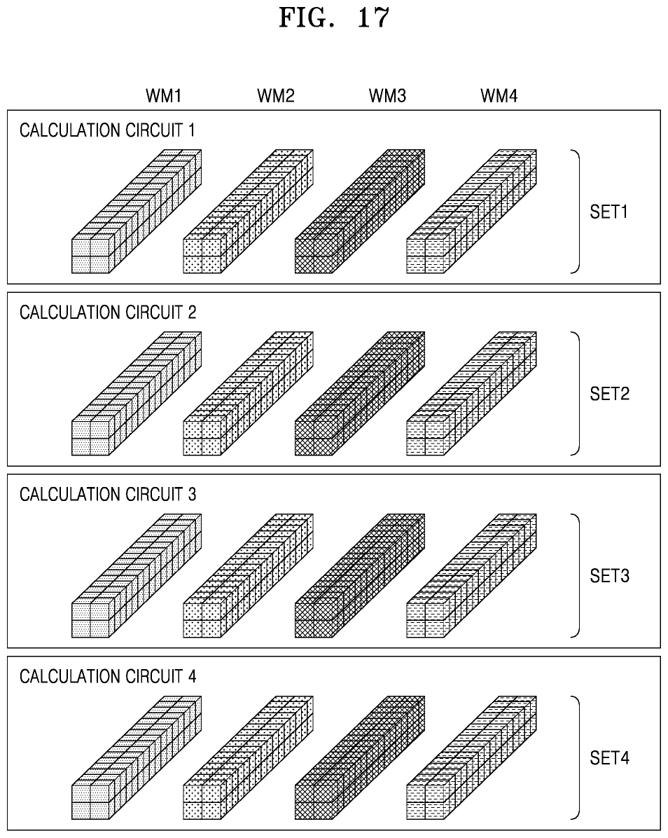

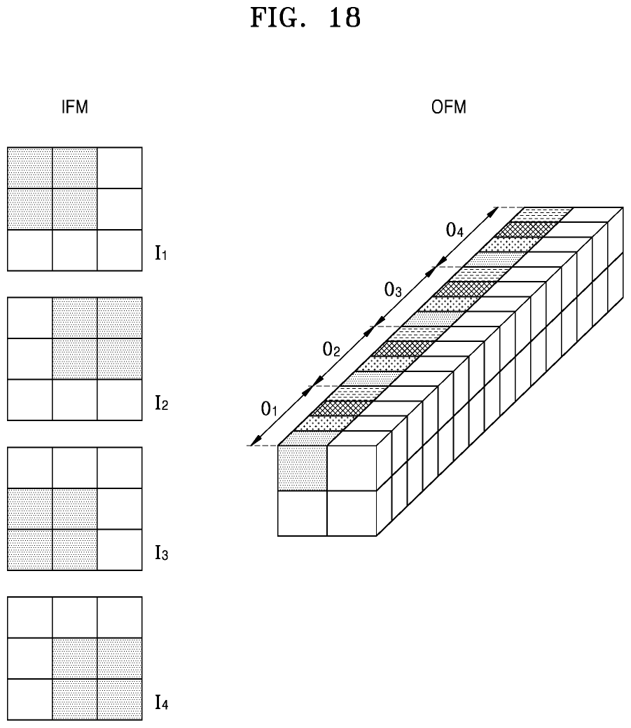

FIG. 17 is a view of weight map sets including additional weight maps generated according to an embodiment, and FIG. 18 is a view of an output feature map generated by a weight map set including additional weight maps.

Referring to FIG. 17, an additional weight map corresponding to a target weight map may be generated based on the number of available channels of the output feature map. The NPU device 10 may generate an additional weight map by determining whether to generate an additional weight map during an inference process for generating inferred data based on input data. However, the NPU device 10 according to an embodiment may determine whether to generate an additional weight map based on the number of weight maps generated during a training process for generating a weight map.

The NPU device 10 may generate an additional weight map such that the number of target weight maps and additional weight maps becomes a maximum number that is less than or equal to the number of available channels of the output feature map. For example, when the number of available channels of the output feature map is 16 and the number of target weight maps is 4, because a maximum of 12 additional weight maps may be generated, the NPU device 10 may generate three additional weight maps for four target weight maps, respectively. A weight map in which a target weight map and an additional weight map have different weights may be allocated to each calculation circuit 12 as one weight map set. Therefore, the weight map set allocated to each calculation circuit 12 may be a weight map set having a weight map the same as that of the weight map set allocated to the other calculation circuit 12.

Referring to FIGS. 17 and 18, the NPU device 10 may generate an output feature map based on a target weight map and an additional weight map. For example, the NPU device 10 may generate a first output feature map block O₁ by performing a convolution operation on first input feature map blocks I₁ in input feature maps and a first weight map set SET1. For example, the first input feature map blocks I₁ may be input feature map blocks corresponding to first row and first column, first row and second column, second row and first column, and second row and second column in a 3*3 input feature map, and the first calculation circuit 12a may receive a first input feature map block I₁ from the first vector generator 11a. The first calculation circuit 12a receiving the first input feature map block I₁ may generate the first output feature map block O₁ based on the first weight map set SET1. In this way, a second calculation circuit 12b to a fourth calculation circuit 12d may generate a second output feature map block O₂ to a fourth output feature map O₄ by performing a convolution operation in parallel based on second input feature map blocks I₂ to fourth input feature map blocks I₄.

FIG. 18 illustrates generating an output feature map block without generating the input feature map vector IFMV for input feature map blocks. However, when the number of channels of an input feature map is limited as described above in FIGS. 7 to 14, the NPU device 10 may perform a convolution operation based on weight maps including an additional weight map by generating the input feature map vector IFMV. In other words, the process in the case where the channel of the input feature map is limited in FIGS. 7 to 14 and the process in the case where the channel of the output feature map is limited in FIGS. 15 to 18 are described separately. However, when the number of channels of the input feature map and the number of channels of the output feature map are limited, the NPU device 10 according to an embodiment may generate an output feature map by performing the both processes.

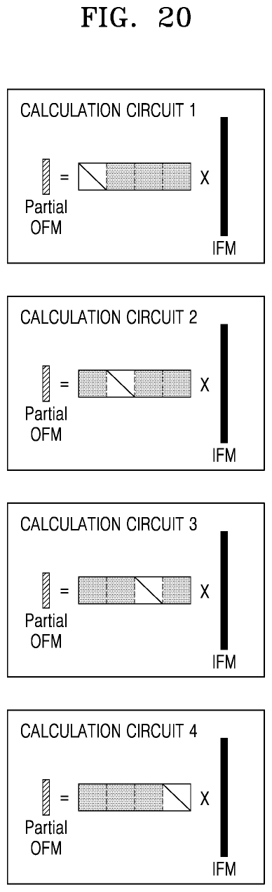

FIG. 19 is a view of an input feature map including the plurality of input feature map blocks BL when a depth-wise convolution operation is performed, and FIG. 20 is a view of a configuration of the calculation circuit 12 of a comparative example for performing the depth-wise convolution operation.

Referring to FIG. 19, the NPU device 10 of the inventive concept may generate the input feature map vector IFMV when a depth-wise convolution operation is requested even when a number of channels of an input feature map is equal to an available number of channels of the NPU device 10. The depth-wise convolution operation may be a method of calculating a neural network that reduces the amount of calculation and enables operation in real time. The depth-wise convolution operation may mean performing a convolution operation after generating a weight map of a 2D structure by separating each channel from a weight map of a 3D structure. In other words, when the NPU device 10 performs the depth-wise convolution operation, the NPU device 10 may not perform convolution in a channel direction, but may only perform a convolution operation in a spatial direction.

Referring to FIG. 20, when the NPU device 10 according to the comparative embodiment performs a depth-wise convolution operation, each calculation circuit 12 may generate an output feature map for one input feature map block BL by performing a convolution operation at different timings based on weight maps having different weights. For example, when the first input feature map block BL1 is provided to the four calculation circuits 12, the NPU device 10 may perform a convolution operation on a first channel area of the first input feature map block BL1 and a first weight map set by activating the first calculation circuit 12a at first timing. At second timing after the first timing, the NPU device 10 may perform a convolution operation on a second channel area of the first input feature map block BL1 and a second weight map set by activating the second calculation circuit 12b. In the same way, the NPU device 10 may output a plurality of output feature map block elements for the first input feature map block BL by performing a convolution operation for third and fourth channel areas in the third calculation circuit 12c and the fourth calculation circuit 12d at a third timing and a fourth timing respectively. For example, the first channel area may be first to fourth channels CH1 to CH4, and the fourth channel area may be thirteenth to sixteenth channels CH13 to CH16.

In this case, the number of output feature map elements may correspond to the number of weight maps included in the plurality of calculation circuits 12, and may correspond to the number of channels of an input feature map when a depth-wise convolution is performed. That is, the number of channels of an input feature map may be the same as the number of channels of an output feature map.

According to a comparative example, the NPU device 10 does not perform an operation by activating only one calculation circuit and deactivating the remaining calculation circuits while generating output feature map elements for one input feature map block BL. On the other hand, the NPU device 10 of an embodiment may generate output plurality of feature maps during the same time by performing a convolution operation on a second input feature map block BL2 at timing in which convolution operation is performed on a first input feature map block BL1.

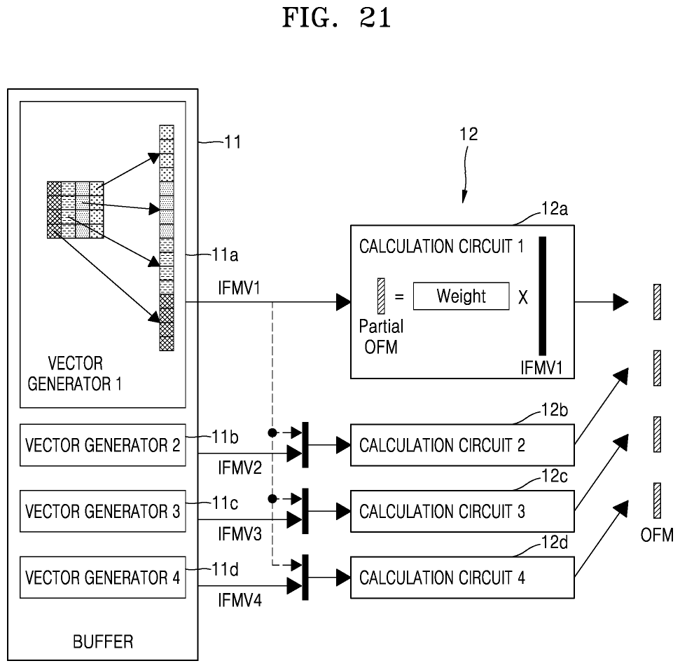

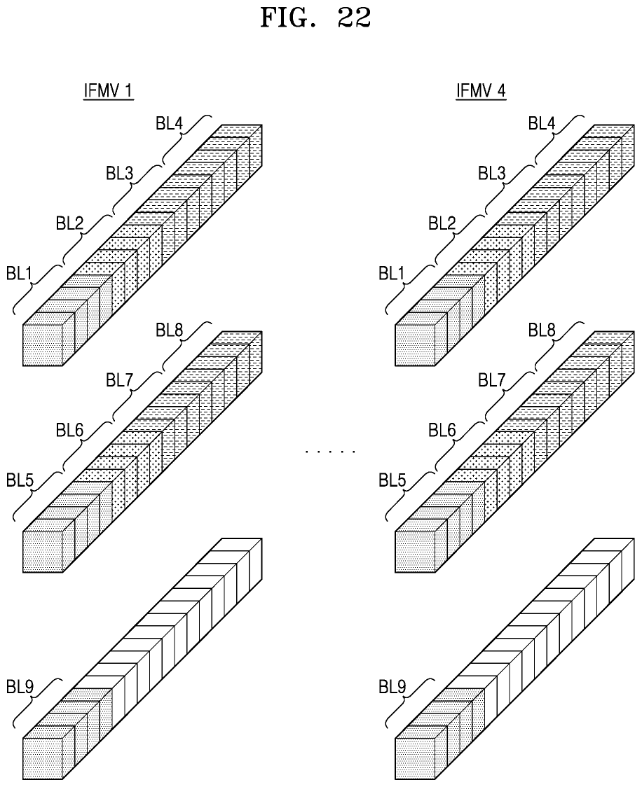

FIG. 21 is a block diagram showing a configuration of generating an output feature map by generating the input feature map vector IFMV when a depth-wise convolution operation is performed, and FIG. 22 is a view of input feature map vectors IFMV generated on the same channel area in a plurality of input feature map blocks BL when a depth-wise convolution operation is performed.

Referring to FIG. 21, the plurality of vector generators 11 may generate the input feature map vector IFMV based on an input feature map element corresponding to a partial channel area in the plurality of input feature map blocks BL1 to BL9. In more detail, each vector generator 11 may generate the input feature map vector IFMV with input feature map elements corresponding to a preset channel area. Referring to FIG. 22, the first vector generator 11a may generate the first input feature map vector IFMV1 by connecting input feature map elements corresponding to the first to fourth channels CH1 to CH4 in the first to ninth input feature map blocks BL1 to BL9. In the same way, as in the embodiment of FIG. 19, in a situation where all channels of an input feature map are full up to available channels, four input feature map vectors IFMV1 to IFMV4 may be generated from the four vector generators 11, respectively.

According to a comparative example, because the same input feature map block BL is provided to each of the calculation circuits 12, it is necessary to wait until some of the input feature map blocks BL are convolved by each of the calculation circuits 12. On the contrary, each of the vector generators 11 according to an embodiment may provide the input feature map vectors IFMV1 to IFMV4 respectively corresponding to different channel area to a corresponding calculation circuit 12.

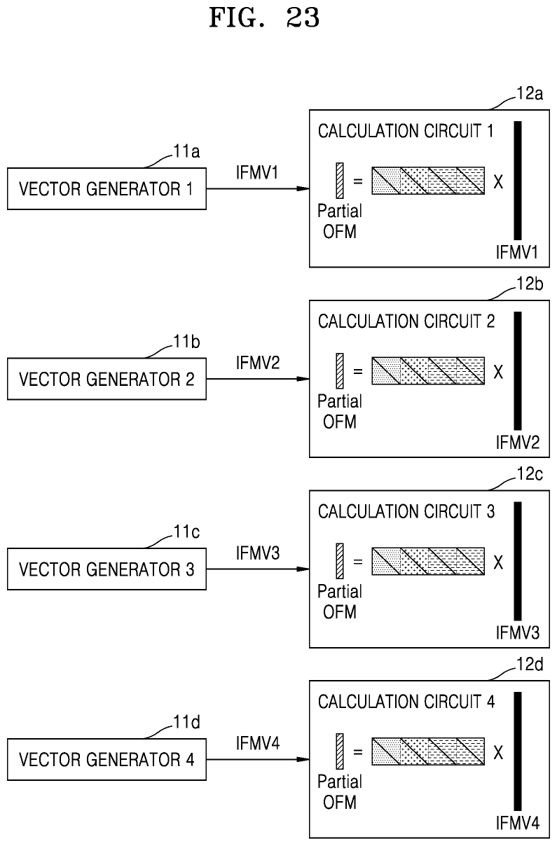

FIG. 23 is a view illustrating a plurality of calculation circuits 12 performing a depth-wise convolution operation according to the embodiment of FIG. 21.

Referring to FIG. 23, unlike the comparative example of FIG. 20, the NPU device 10 may perform a convolution operation on a plurality of input feature map blocks BL without a period in which the calculation circuits 12 are deactivated. The calculation circuits 12 may receive input feature map vectors IFMV from corresponding vector generators 11, respectively. The input feature map vectors IFMV may include input feature map elements of the same channel area in the plurality of input feature map blocks BL, respectively, as described above with reference to FIG. 22.

The calculation circuits 12 of the NPU device 10 may perform a convolution operation on the input feature map vectors IFMV at all timings to generate output feature map elements for the plurality of input feature map blocks BL, respectively. For example, the calculation circuits 12 may receive the first to fourth input feature map vectors IFMV1 to IFMV4 generated for different channel areas, respectively, based on the first to fourth input feature map blocks BL1 to BL4. The first calculation circuit 12a receiving the first input feature map vector IFMV1 may perform a convolution operation on input feature map elements corresponding to the first to fourth channels CH1 to CH4 in the first input feature map block BL1 at first timing. In the same way, the second calculation circuit 12b to the fourth calculation circuit 12d may perform a convolution operation on the fifth to eighth channels CH5 to CH8, ninth to 12th channels CH9 to CH12, and the thirteenth to sixteenth channels CH13 to CH16 in the first input feature map block BL1 at the first timing. That is, a convolution operation performed by the NPU device 10 according to a comparative example at second timing to fourth timing may be performed by the NPU device 10 according to an embodiment of the inventive concept at the first timing.

When the NPU device 10 according to the comparative embodiment performs a depth-wise convolution operation on an input feature map including 16 channels according to the embodiment of FIG. 19 based on 16 weight maps, the NPU device 10 may generate 16 output feature map elements for one input feature map block BL during four timings. On the other hand, the NPU device 10 of the inventive concept only needs to perform a convolution operation for one timing to generate 16 output feature map elements identical to those of the comparative example by generating the input feature map vector IFMV, and may generate 64 output feature map elements for 4 input feature map blocks BL during four timings.

According to one or more example embodiments of the disclosure, one or more components or elements of the NPU device may be implemented as a hardware. However, the disclosure is not limited thereto, and as such, according to an example embodiment, one or more components or elements of the NPU device may be implemented as a software or a combination of a hardware and software. For example, according to an example embodiment, the vector generator, the weight vector generator, the weight map generator, etc., may each be implemented by a hardware, a software module or a combination of hardware and software.

While the inventive concept has been particularly shown and described with reference to example embodiments thereof, it will be understood that various changes in form and details may be made therein without departing from the spirit and scope of the following claims.

1. A method of generating an output feature map based on an input feature map, the method comprising:
generating an input feature map vector for a plurality of input feature map blocks based on a number of channels of the input feature map being less than a number of reference channels;
performing a convolution operation between the input feature map vector and weight maps, including one or more target weight maps and an additional weight map that has a weight identical to one of the one or more target weight maps, based on a number of the one or more target weight maps being less than a reference number; and
generating an output feature map based on the convolution operation.

2. The method of claim 1, wherein the input feature map vector is vector information generated based on the plurality of input feature map blocks corresponding to a size of a weight map in a three dimensional (3D) input feature map.

3. The method of claim 2, wherein each of the input feature map blocks comprises:
a data block corresponding to one or more channels in which an input value exists from among a plurality of available channels, and
wherein the generating of the input feature map vector comprises:
generating each of the plurality of input feature map blocks as a partial input feature map vector.

4. The method of claim 3, wherein the generating of the input feature map vector comprises:
generating the input feature map vector by combining a plurality of partial input feature map vectors, corresponding to each of each of the plurality of input feature map blocks, in an order of convolution operations.

5. The method of claim 4, wherein a length of the input feature map vector is determined based on a ratio of the number of the one or more channels in which the input value exists to a number of available channels.

6. The method of claim 2, wherein the generating of the input feature map vector comprises:
generating the input feature map vector as an input value corresponding to an identical channel in the plurality of input feature map blocks, based on a determination to perform a depth-wise convolution operation.

7. The method of claim 2, wherein the performing of the convolution operation comprises:
generating a weight vector having a size corresponding to the input feature map vector from the weight maps; and
performing a dot product operation on the weight vector and the input feature map vector.

8. (canceled)

9. The method of claim 1, wherein the performing of the convolution operation comprises:
generating the additional weight map having the weight identical to the one of the one or more target weight maps, based on a number of the target weight maps being less than the reference number.

10. The method of claim 9, wherein the generating of the additional weight map comprises:
determining a number of additional weight maps to be generated based on a ratio of the number of the one or more target weight maps to a number of available channels.

11. The method of claim 9, wherein the performing of the convolution operation comprises:
performing, by the one or more target weight maps and the additional weight map, a convolution operation on different input feature map blocks in the input feature map.

12. (canceled)

13. A Neural Processing Unit (NPU) device comprising:
a vector generator configured to generate an input feature map vector for a plurality of input feature map blocks based on a number of channels of an input feature map being less than a number of reference channels; and
a calculation circuit configured to:
perform a convolution operation between the input feature map vector and weight maps, including one or more target weight maps and an additional weight map having a weight identical to one of the one or more target weight maps, based on a number of the one or more target weight maps being less than a reference number, and
generate an output feature map based on a result of the convolution operation.

14. The NPU device of claim 13, wherein the input feature map vector is vector information generated based on the plurality of input feature map blocks corresponding to a size of a weight map in a 3 dimensional (3D) input feature map.

15-17. (canceled)

18. The NPU device of claim 14, wherein the vector generator generates the input feature map vector as an input value corresponding to an identical channel in the plurality of input feature map blocks, based on a determination to perform a depth-wise convolution operation.

19-20. (canceled)

21. The NPU device of claim 13, further comprising:
a weight map generator configured to generate the additional weight map having the weight identical to the one of the one or more target weight maps, based on a number of the target weight maps being less than the reference number.

22. (canceled)

23. The NPU device of claim 21, wherein the calculation circuit performs, based on the one or more target weight maps and the one or more additional weight map, a convolution operation on different input feature map blocks in the input feature map.

24. (canceled)

25. An operating method of a Neural Processing Unit (NPU) device that performs a convolution operation based on convolution operation scheduling, the operating method comprising:
adjusting the convolution operation scheduling based on at least one of a number of channels of an input feature map and a number of channels of an output feature map being less than a number of reference channels;
performing a convolution operation of a weight map on the input feature map based on the adjusted convolution operation scheduling; and
generating the output feature map based on the convolution operation.

26. The operating method of claim 25, wherein the adjusting of the convolution operation scheduling comprises:
generating an input feature map vector for a plurality of input feature map blocks based on the number of channels of the input feature map being less than a number of first reference channels; and
adjusting the convolution operation scheduling based on a length of the input feature map vector with respect to a number of available channels.

27. (canceled)

28. The operating method of claim 25, wherein the adjusting of the convolution operation scheduling comprises:
generating the input feature map vector as an input value corresponding to an identical channel in a plurality of input feature map blocks, based on a determination to perform a depth-wise convolution operation.

29. The operating method of claim 25, wherein the adjusting of the convolution operation scheduling comprises:
generating an additional weight map having a weight identical to a target weight map, based on the number of channels of the output feature map being less than a number of second reference channels; and
adjusting the convolution operation scheduling, for the target weight map and the additional weight map to perform a convolution operation on different input feature map blocks.

30. The operating method of claim 29, wherein, when the target weight map numbers less than the second reference number, more channels of the output feature map than the number of target weight maps are generated by generating the additional weight map.

31. (canceled)
